(19) United States
(12) Patent Application Publication
(10) Pub. No.: US 2026/0088226 A1
(43) Pub. Date: Mar. 26, 2026

(54) MULTILAYER CERAMIC ELECTRONIC COMPONENT

(71) Applicant: Murata Manufacturing Co., Ltd., Nagaokakyo-shi (JP)

(72) Inventor: Takefumi TAKAHASHI, Nagaokakyo-shi (JP)

(21) Appl. No.: 19/266,283

(22) Filed: Jul. 11, 2025

(30) Foreign Application Priority Data
Sep. 24, 2024 (JP) 2024-165306

(51) Int. Cl. H01G 4/232; H01G 4/008; H01G 4/12; H01G 4/248; H01G 4/30

(52) U.S. Cl. CPC H01G 4/2325; H01G 4/008; H01G 4/1227; H01G 4/1236; H01G 4/248; H01G 4/30

(57) ABSTRACT

In a multilayer ceramic capacitor, a first outer electrode layer includes a first base electrode layer, a first electroconductive resin layer on the first base electrode layer, and a first plating layer on the first electroconductive resin layer. The first plating layer includes a plating layer body, and a connection area extending from the plating layer body through the first electroconductive resin layer, and connected to the first base electrode layer. A connection portion between the connection area and the first base electrode layer is adjacent to a first inner electrode layer.

### CROSS REFERENCE TO RELATED APPLICATIONS

This application claims the benefit of priority to Japanese Patent Application No. 2024-165306 filed on Sep. 24, 2024. The entire contents of this application are hereby incorporated herein by reference.

### BACKGROUND OF THE INVENTION

### 1. Field of the Invention

The present invention relates to multilayer ceramic electronic components.

### 2. Description of the Related Art

Examples of a multilayer ceramic electronic component include a multilayer ceramic capacitor. Japanese Unexamined Patent Application Publication No. 2022-67931 describes a multilayer ceramic capacitor including an outer electrode including a resin electrode layer. The resin electrode layer is disposed to cover a thick Cu layer defining and functioning as a base electrode layer. The resin electrode layer is covered with a Ni plating layer and a Sn plating layer. The electroconductive resin layer includes an electroconductive filler and resin. Ag is used as the electroconductive filler. Epoxy resin is used as a resin. Multiple pieces of the electroconductive filler come into contact with each other to ensure electrical connection in the electroconductive resin layer.

Japanese Unexamined Patent Application Publication No. 2022-67931 describes a multilayer ceramic capacitor including a second electrode layer formed on the first electrode layer by curing an electroconductive resin paste.

In the multilayer ceramic capacitor described in Japanese Unexamined Patent Application Publication No. 2022-67931, the second electrode layer includes resin, and thus has high electric resistance. The first electrode layer and the plating layer are thus directly connected to each other to reduce the electric resistance.

However, directly connecting the first electrode layer and the plating layer allows stress to concentrate on the connection portion, and thus may allow the stress to propagate through the plating layer into the multilayer body.

In addition, in the multilayer ceramic capacitor described in Japanese Unexamined Patent Application Publication No. 2022-67931, to directly connect the first electrode layer and the plating layer, the thickness of the second electrode layer is gradually reduced to ensure that a portion of the first electrode layer is exposed at the end. This structure thus may degrade moisture resistance due to a reduction of the effect of improving bending strength with the second electrode layer, or an increase of the exposure area of the first electrode layer.

### SUMMARY OF THE INVENTION

Example embodiments of the present invention provide multilayer ceramic electronic components that each reduce or prevent degradation of bending strength and moisture resistance and reduce or prevent an excessive increase of electric resistance.

A multilayer ceramic electronic component according to an example embodiment of the present invention includes a multilayer body including a first surface and a second surface opposed to each other in a lamination direction, a third surface and a fourth surface opposed to each other in a first direction orthogonal or substantially orthogonal to the lamination direction, and a fifth surface and a sixth surface opposed to each other in a second direction orthogonal or substantially orthogonal to the lamination direction and the first direction, a first outer electrode on the third surface, and a second outer electrode on the fourth surface. The multilayer body includes an inner layer portion including a plurality of inner electrodes and a plurality of dielectric layers laminated on one another, the inner layer portion including an area extending from a first inner electrode closest to the first surface to a second inner electrode positioned closest to the second surface, a first outer layer portion laminated at a portion of the inner layer portion closer to the first surface, and a second outer layer portion laminated at a portion of the inner layer portion closer to the second surface. The first outer electrode includes a base electrode layer, a resin electrode layer on the base electrode layer, and a plating layer on the resin electrode layer. The plating layer includes a plating layer body, and a connection area extending from the plating layer body through the resin electrode layer and connected to the base electrode layer. A connection portion between the connection area and the base electrode layer is adjacent to the first inner electrode.

Example embodiments of the present invention provide multilayer ceramic electronic components each with reduced or prevented degradation of bending strength and moisture resistance while reducing or preventing an excessive increase of electric resistance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to a first example embodiment of the present invention.

FIG. 2 is a cross-sectional view of the multilayer ceramic capacitor illustrated in FIG. 1 taken along line II-II.

FIG. 3 is a cross-sectional view of the multilayer ceramic capacitor illustrated in FIG. 1 taken along line III-III.

FIG. 4 is an enlarged view of an area P1 in FIG. 2, and is a partial cross-sectional view of the multilayer ceramic capacitor.

FIG. 5 is a diagram of the multilayer ceramic capacitor viewed in the direction indicated by arrow V in FIG. 4, and is a partial side view of the multilayer ceramic capacitor viewed in the length direction.

FIG. 6 is a partial cross-sectional view of a multilayer ceramic capacitor according to a second example embodiment of the present invention.

FIG. 7 is a partial side view of a multilayer ceramic capacitor according to a third example embodiment viewed in the length direction of the multilayer ceramic capacitor.

### DETAILED DESCRIPTION OF THE EXAMPLE EMBODIMENTS

Example embodiments of the present invention will be described in detail below with reference to the drawings.

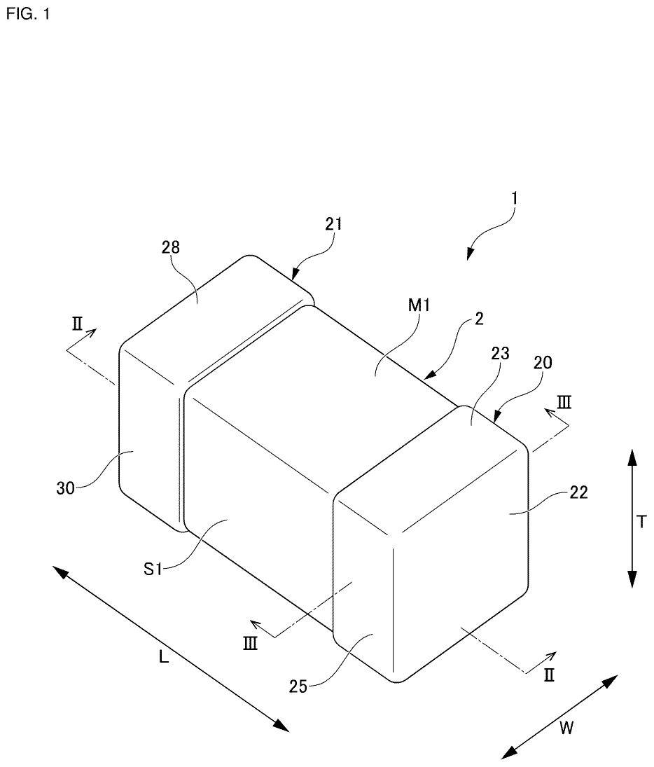

Example embodiments of the present invention are described based on a multilayer ceramic capacitor 1, which is an example of a multilayer ceramic electronic component. FIG. 1 is a perspective view of the multilayer ceramic capacitor 1 according to a first example embodiment of the present invention.

### Multilayer Body

A multilayer body 2 includes multiple dielectric layers and multiple inner electrode layers that are laminated. The multilayer body 2 has a rectangular or substantially rectangular parallelepiped shape. In the multilayer body 2, a direction in which the dielectric layers and the inner electrode layers are laminated is referred to as a height direction T. A direction orthogonal or substantially orthogonal to the height direction T is referred to as a width direction W. A direction orthogonal or substantially orthogonal to the height direction T and the width direction W is referred to as a length direction L.

In the multilayer body 2, two surfaces opposite to each other in the height direction T are referred to as a first main surface M1 and a second main surface M2. In the multilayer body 2, two surfaces opposite to each other in the width direction W are referred to as a first side surface S1 and a second side surface S2. Two surfaces opposite to each other in the length direction L are referred to as a first end surface E1 and a second end surface E2. The first main surface M1 defines and functions as a mount surface of the multilayer ceramic capacitor 1. The mount surface is a surface of the multilayer ceramic capacitor 1 that faces a circuit board when, for example, the multilayer ceramic capacitor 1 is mounted on the circuit board.

The cross section of the multilayer body 2 taken along line II-II in FIG. 1 is referred to as a LT cross section. The cross section of the multilayer body 2 taken along line III-III in FIG. 1 is referred to as a WT cross section.

In the multilayer body 2, corner portions and ridgeline portions are preferably rounded. Each corner portion is a portion where three surfaces of the multilayer body 2 cross. Each ridgeline portion is a portion where two surfaces of the multilayer body 2 cross. Protrusions and/or recesses may be provided over a portion of or an entirety of the main surfaces, the side surfaces, and/or the end surfaces.

### Dielectric Layers

The total dielectric layers laminated in the multilayer body 2 are, for example, preferably greater than or equal to 15 layers and less than or equal to 2000 layers. The dielectric layers mainly include a ceramic material. An example usable as the ceramic material is a dielectric ceramic including, for example, BaTiO₃, CaTiO₃, SrTiO₃, or CaZrO₃ as a main component. Alternatively, for example, a dielectric ceramic obtained by adding a secondary component such as a Mn compound, a Fe compound, a Cr compound, a Co compound, or a Ni compound to any of these main components may be used as the ceramic material.

In the present example embodiment, the multilayer ceramic capacitor 1 is described. As described above, the multilayer ceramic capacitor 1 is an example of a multilayer ceramic electronic component. When the multilayer body 2 includes a piezoelectric ceramic material, the multilayer ceramic electronic component defines and functions as a ceramic piezoelectric device. Specific examples of a piezoelectric ceramic material include a lead-zirconate-titanate (PZT) ceramic material.

When the multilayer body 2 includes a semiconductor ceramic material, the multilayer ceramic electronic component defines and functions as a thermistor element. Specific examples of a semiconductor ceramic material include a spinel ceramic material.

When the multilayer body 2 includes a magnetic ceramic material, the multilayer ceramic electronic component defines and functions as an inductor element. When the multilayer ceramic electronic component defines and functions as an inductor element, the inner electrode layer defines a coil conductor. Specific examples of a magnetic ceramic material include a ferrite ceramic material.

The thickness of one dielectric layer is, for example, preferably greater than or equal about to 0.5 μm and less than or equal to about 10 μm.

### Divisions of Multilayer Body

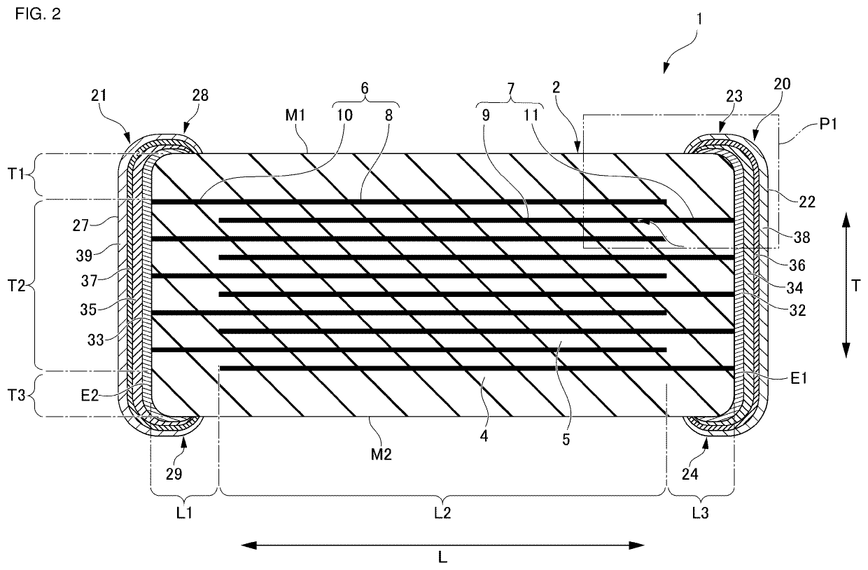

Based on FIG. 2, divisions of the multilayer body 2 in a height direction T and a length direction L are described. FIG. 2 is a cross-sectional view of the multilayer body 2 taken along line II-II in FIG. 1. The multilayer body 2 can be divided into a first outer layer portion T1, an inner layer portion T2, and a second outer layer portion T3 in the height direction T. The first outer layer portion T1, the inner layer portion T2, and the second outer layer portion T3 are arranged and laminated in this order in the height direction T from the first main surface M1 toward the second main surface M2.

The first outer layer portion T1 is a portion between the first main surface M1 and an inner electrode layer closest to the first main surface M1. The inner layer portion T2 is an area from the inner electrode layer closest to the first main surface M1 (in the present example embodiment, a first outermost inner electrode layer 6A, described below) to an inner electrode layer closest to the second main surface M2. In the inner layer portion T2, multiple inner electrode layers face one another. The second outer layer portion T3 is a portion between the second main surface M2 and the inner electrode layer closest to the second main surface M2.

More specifically, the first outer layer portion T1 includes multiple dielectric layers positioned between the first main surface M1 and the inner electrode layer closest to the first main surface M1. The second outer layer portion T3 includes multiple dielectric layers positioned between the second main surface M2 and the inner electrode layer closest to the second main surface M2.

Of the dielectric layers, the dielectric layers disposed in the first outer layer portion T1 and the second outer layer portion T3 are defined as outer dielectric layers 4. Of the dielectric layers, the dielectric layers disposed in the inner layer portion T2 are defined as inner dielectric layers 5. The first outer layer portion T1 and the second outer layer portion T3 may be made of the same material, or different materials or materials with different amounts of additives.

The multilayer body 2 may have any dimensions. The dimension of the multilayer body 2 in the length direction L is defined as a L dimension. Preferably, for example, the L dimension is greater than or equal to about 0.20 mm and less than or equal to about 3.20 mm. The dimension of the multilayer body 2 in the width direction W is defined as a W dimension. Preferably, for example, the W dimension is greater than or equal to about 0.10 mm and less than or equal to about 2.50 mm. The dimension of the multilayer body 2 in the height direction T is defined as a T dimension. Preferably, for example, the T dimension is greater than or equal to about 0.10 mm and less than or equal to about 2.50 mm.

The divisions of the multilayer body 2 in the length direction L are described. The multilayer body 2 can be divided into a first end portion L1, an L-facing electrode portion L2, and a second end portion L3 in the length direction L. The first end portion L1, the L-facing electrode portion L2, and the second end portion L3 are arranged in this order in the length direction L, from the second end surface E2 toward the first end surface E1.

The L-facing electrode portion L2 is a portion in which the inner electrode layers face one another in the height direction T. The first end portion L1 is a portion between the L-facing electrode portion L2 and the second end surface E2. The second end portion L3 is a portion between the L-facing electrode portion L2 and the first end surface E1. The L-facing electrode portion L2 is a portion corresponding to a facing electrode portion of the inner electrode layer. The first end portion L1 and the second end portion L3 are portions corresponding to extraction electrode portions of the inner electrode layer. The facing electrode portions and the extraction electrode portions are described below. The first end portion L1 and the second end portion L3 are also referred to as L gaps.

The L-facing electrode portion L2 is a portion corresponding to the facing electrode portion of the inner electrode layer. Thus, the L-facing electrode portion L2 is also referred to as an L-direction inner layer portion.

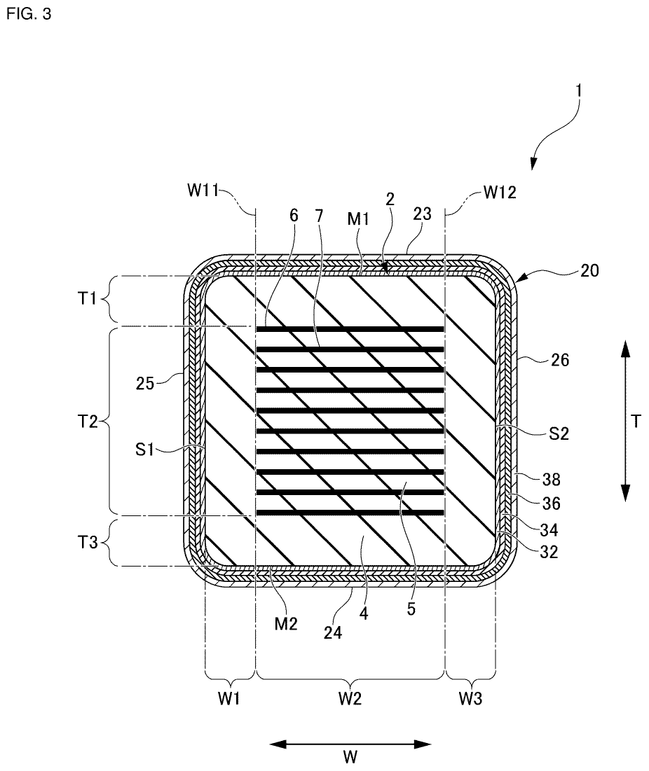

With reference to FIG. 3, the divisions of the multilayer body 2 in the width direction W are described. FIG. 3 is a cross-sectional view taken along line III-III in FIG. 1. The multilayer body 2 can be divided into a first side portion W1, a W-facing electrode portion W2, and a second side portion W3 in the width direction W. The first side portion W1, the W-facing electrode portion W2, and the second side portion W3 are arranged in this order in the width direction W from the first side surface S1 toward the second side surface S2.

The W-facing electrode portion W2 is a portion in which the inner electrode layers face one another in the height direction T. The first side portion W1 is a portion between the W-facing electrode portion W2 and the first side surface S1. The second side portion W3 is a portion between the W-facing electrode portion W2 and the second side surface S2. The first side portion W1 and the second side portion W3 can be also referred to as W gaps.

The W-facing electrode portion W2 is a portion in which the inner electrode layers are disposed. Thus, the W-facing electrode portion W2 can be also referred to as a W-direction inner layer portion.

The first side portion W1 and the second side portion W3 are portions in which no inner electrode layers are disposed in the height direction T. More specifically, the first side portion W1 is a portion positioned closer to the first side surface S1 and including dielectric layers positioned between the first side surface S1 and an outermost surface W11 of the inner layer portion positioned closer to the first side surface S1. The first side portion W1 is also referred to as a near-first-side-surface outer layer portion.

Similarly, the second side portion W3 is a portion positioned closer to the second side surface S2, and including dielectric layers positioned between the second side surface S2 and an outermost surface W12 of the inner layer portion positioned closer to the second side surface S2. The second side portion W3 is also referred to as a near-second-side-surface outer layer portion.

### Inner Electrode Layers

The inner electrode layers include multiple first inner electrode layers 6 and multiple second inner electrode layers 7. The first inner electrode layers 6 are inner electrodes exposed on the second end surface E2. The second inner electrode layers 7 are inner electrodes exposed on the first end surface E1.

Each of the first inner electrode layers 6 includes a first facing electrode portion 8 facing a corresponding one of the second inner electrode layers 7, and a first extraction electrode portion 10 extending from the first facing electrode portion 8 to the second end surface E2 of the multilayer body 2. The first extraction electrode portion 10 includes an end portion positioned closer to the second end surface E2 extending to the second end surface E2 of the multilayer body 2. The end portion of the first extraction electrode portion 10 extending to the second end surface E2 is exposed on the second end surface E2.

Each of the second inner electrode layers 7 includes a second facing electrode portion 9 facing a corresponding one of the first inner electrode layers 6, and a second extraction electrode portion 11 extending from the second facing electrode portion 9 to the first end surface E1 of the multilayer body 2. The second extraction electrode portion 11 includes an end portion positioned closer to the first end surface E1 extending to the surface of the first end surface E1 of the multilayer body 2. The end portion of the second extraction electrode portion 11 extending to the first end surface E1 is exposed on the first end surface E1.

The first facing electrode portion 8 and the second facing electrode portion 9 may have any shape. Preferably, the first facing electrode portion 8 and the second facing electrode portion 9 have a rectangular or substantially rectangular shape. However, the first facing electrode portion 8 and the second facing electrode portion 9 may include rounded corner portions. The corner portions of the first facing electrode portion 8 and the second facing electrode portion 9 may be beveled. Beveling corner portions indicate tapering corner portions.

The first extraction electrode portion 10 and the second extraction electrode portion 11 may have any shape. Preferably, the first extraction electrode portion 10 and the second extraction electrode portion 11 have a rectangular or substantially rectangular shape. However, the first extraction electrode portion 10 and the second extraction electrode portion 11 may included rounded corner portions. The corner portions of the first extraction electrode portion 10 and the second extraction electrode portion 11 may be beveled. Beveling corner portions indicates tapering corner portions.

The first facing electrode portion 8 and the first extraction electrode portion 10 may have the same or substantially the same width. Alternatively, either the first facing electrode portion 8 or the first extraction electrode portion 10 may have a smaller width than the other.

Similarly, the second facing electrode portion 9 and the second extraction electrode portion 11 may have the same or substantially the same width. Alternatively, either the second facing electrode portion 9 or the second extraction electrode portion 11 may have a smaller width than the other.

The first inner electrode layers 6 and the second inner electrode layers 7 may be made of an appropriate electroconductive material, for example, a metal such as Ni, Cu, Ag, Pd, or Au, or an alloy including any of these metals such as a Ag—Pd alloy. When a Sn layer is disposed at the interface between the inner electrode and the inner dielectric layer, electric field concentration at the interface between the inner electrode and the inner dielectric layer can be reduced.

The inner electrode layer may have a width (the dimension in the width direction W) decreasing as it extends toward the exposed end.

An amount of deviation, in the width direction W, between the inner electrode layers adjacent in the height direction T may be, for example, less than or equal to about 1.0 μm.

In the multilayer ceramic capacitor 1 according to the present example embodiment, the first facing electrode portion 8 and the second facing electrode portion 9 face each other with the inner dielectric layer 5 interposed therebetween to generate capacitance. Thus, the multilayer ceramic capacitor 1 has capacitor characteristics.

Preferably, the first inner electrode layers 6 and the second inner electrode layers 7 may each have a thickness of, for example, greater than or equal to about 0.2 μm and less than or equal to about 2.0 μm. Preferably, the total number of the first inner electrode layers 6 and the second inner electrode layers 7 is, for example, greater than or equal to 15 layers and less than or equal to 2000 layers.

### Outer Electrode Layers

The outer electrode layers include a first outer electrode layer 20 and a second outer electrode layer 21. The first outer electrode layer 20 is connected to the second inner electrode layers 7. The first outer electrode layer 20 is disposed over an area extending from the first end surface E1 to a portion of the first main surface M1, a portion of the second main surface M2, a portion of the first side surface S1, and a portion of the second side surface S2.

The first outer electrode layer 20 on the first end surface E1 is referred to as a first over-first-end-surface outer electrode layer 22, the first outer electrode layer 20 on the first main surface M1 is referred to as a first over-first-main-surface outer electrode layer 23, the first outer electrode layer 20 on the second main surface M2 is referred to as a first over-second-main-surface outer electrode layer 24, the first outer electrode layer 20 on the first side surface S1 is referred to as a first over-first-side-surface outer electrode layer 25, and the first outer electrode layer 20 on the second side surface S2 is referred to as a first over-second-side-surface outer electrode layer 26.

The second outer electrode layer 21 is connected to the first inner electrode layers 6. The second outer electrode layer 21 is disposed over an area extending from the second end surface E2 to a portion of the first main surface M1, a portion of the second main surface M2, a portion of the first side surface S1, and a portion of the second side surface S2.

The second outer electrode layer 21 on the second end surface E2 is referred to as a second over-second-end-surface outer electrode layer 27, the second outer electrode layer 21 on the first main surface M1 is referred to as a second over-first-main-surface outer electrode layer 28, the second outer electrode layer 21 on the second main surface M2 is referred to as a second over-second-main-surface outer electrode layer 29, the second outer electrode layer 21 on the first side surface S1 is referred to as a second over-first-side-surface outer electrode layer 30, and the second outer electrode layer 21 on the second side surface S2 is referred to as a second over-second-side-surface outer electrode layer (not illustrated).

The first outer electrode layer 20 includes a first base electrode layer 32, a first electroconductive resin layer 34, a first inner plating layer 36, and a first outer plating layer 38. The second outer electrode layer 21 includes a second base electrode layer 33, a second electroconductive resin layer 35, a second inner plating layer 37, and a second outer plating layer 39.

The first base electrode layer 32 and the second base electrode layer 33 include an electroconductive metal and a glass component. The first electroconductive resin layer 34 and the second electroconductive resin layer 35 include a metal component and a thermosetting resin. The first inner plating layer 36 and the second inner plating layer 37 may be, for example, Ni plating layers. The first outer plating layer 38 and the second outer plating layer 39 may be, for example, Sn plating layers. Hereafter, these layers are sequentially described.

### Base Electrode Layers

The base electrode layers include the first base electrode layer 32 and the second base electrode layer 33. The first base electrode layer 32 is disposed over an area extending from the first end surface E1 to a portion of the first main surface M1, a portion of the second main surface M2, a portion of the first side surface S1, and a portion of the second side surface S2. The second base electrode layer 33 is disposed over an area extending from the second end surface E2 to a portion of the first main surface M1, a portion of the second main surface M2, a portion of the first side surface S1, and a portion of the second side surface S2.

The first base electrode layer 32 and the second base electrode layer 33 include an electroconductive metal and a glass component. Examples included as an electroconductive metal include at least one of, for example, Cu, Ni, Ag, Pd, a Ag—Pd alloy, or Au. Examples included as a glass component include at least one of, for example, B, Si, Ba, Mg, Al, or Li. The first base electrode layer 32 and the second base electrode layer 33 may include a dielectric component instead of a glass component, or may concurrently include a glass component and a dielectric component.

The base electrode layers may include multiple first base electrode layers 32 and multiple second base electrode layers 33. Alternatively, the first base electrode layer 32 and the second base electrode layer 33 may be formed by, for example, applying an electroconductive paste including glass and metal to a multilayer body, and baking the electroconductive paste. This baking may be performed concurrently with firing inner electrodes or after firing the inner electrodes. As described above, the first base electrode layer 32 and the second base electrode layer 33 are baked layers.

Preferably, the first base electrode layer 32 positioned on the first end surface E1 at a center portion of the first base electrode layer 32 in the height direction T has a thickness of, for example, greater than or equal to about 10 μm and less than or equal to about 150 μm. Similarly, preferably, the second base electrode layer 33 positioned on the second end surface E2 at a center portion of the second base electrode layer 33 in the height direction T has a thickness of, for example, greater than or equal to about 10 μm and less than or equal to about 150 μm.

When the first base electrode layer 32 and the second base electrode layer 33 are disposed on the first main surface M1, the second main surface M2, the first side surface S1, and the second side surface S2, preferably, the thickness of the first base electrode layer 32 or the second base electrode layer 33 positioned on the first main surface M1, the second main surface M2, the first side surface S1, and the second side surface S2 at a center portion of the first base electrode layer 32 or the second base electrode layer 33 in the length direction L is, for example, greater than or equal to about 5 μm and less than or equal to about 50 μm.

### Electroconductive Resin Layer

Electroconductive resin layers are disposed on the base electrode layers. The electroconductive resin layers include a resin component and a metal component. The electroconductive resin layers include the first electroconductive resin layer 34 and the second electroconductive resin layer 35. The first electroconductive resin layer 34 and the second electroconductive resin layer 35 include, for example, a thermosetting resin. The first electroconductive resin layer 34 and the second electroconductive resin layer 35 are thus more flexible than the base electrode layer. This is because the base electrode layers are formed from, for example, fired objects including a plating film, a metal component, and a glass component.

This structure can thus reduce or prevent cracks from being produced in the multilayer ceramic capacitor when bending stress is produced in a mount board and the multilayer ceramic capacitor undergoes physical impact or when the multilayer ceramic capacitor undergoes impact attributable to a heat cycle.

Specific examples of thermosetting resins included in the electroconductive resin layer include various known thermosetting resins such as epoxy resin, phenol resin, polyurethane resin, silicone resin, or polyimide resin, for example. Among these, epoxy resin is one of the appropriate resins, because of its high thermal resistance, high moisture resistance, and strong adhesion.

Preferably, the electroconductive resin layer includes a curing agent in addition to a thermosetting resin. When epoxy resin is used as a base resin, any of various known compounds such as, for example, phenolic, aminic, acid anhydride, or imidazole compounds may be used as a curing agent for the epoxy resin.

The first electroconductive resin layer 34 is disposed on the first base electrode layer 32. More specifically, the first electroconductive resin layer 34 covers the first base electrode layer 32. The end portion of the first electroconductive resin layer 34 is in contact with the multilayer body 2.

Similarly, the second electroconductive resin layer 35 is disposed on the second base electrode layer 33. More specifically, the second electroconductive resin layer 35 covers the second base electrode layer 33. The end portion of the second electroconductive resin layer 35 is in contact with the multilayer body 2.

Preferably, the metal component included in the first electroconductive resin layer 34 and the second electroconductive resin layer 35 is a metal filler. Particularly preferably, the metal component includes Ag, for example. Ag may be pure Ag or an alloy including Ag.

Ag may be coated on the surface of metal powder other than Ag, for example. When metal powder with a surface coated with Ag is used, preferably, the metal powder may be powder of Cu, Ni, Sn, Bi or an alloy of any of these, for example.

When Ag is used as a metal filler, advantages described below are obtained. Specifically, Ag among metals has lowest specific resistance. Thus, an electrode with low electric resistance can be provided. In addition, Ag is a noble metal, and is less easily oxidized. Thus, Ag can improve the weatherproof performance of the electroconductive resin layer. Ag used as a metal filler enables use of a low-cost metal as a base material while the characteristics of Ag are maintained.

The metal filler included in the first electroconductive resin layer 34 and the second electroconductive resin layer 35 may have any shape. The metal filler may have a shape such as a spherical or oblate shape. The metal filler may be a mixture of spherical metal powder and oblate metal powder.

The mean particle diameter of the metal filler included in the first electroconductive resin layer 34 and the second electroconductive resin layer 35 is not particularly limited. For example, the metal filler may have a mean particle diameter of greater than or equal to about 0.3 μm and less than or equal to about 10 μm. The mean particle diameter of the metal filler included in the electroconductive resin layer can be obtained by calculation with a laser diffraction method for particle size measurement (based on ISO 13320). This method for measuring the mean particle diameter is applicable to fillers with any shape.

The metal filler included in the first electroconductive resin layer 34 and the second electroconductive resin layer 35 is mainly used for current-carrying performance in the electroconductive resin layer. More specifically, with the contact between particles of the metal filler, current-carrying paths are provided in the electroconductive resin layer.

As described above, examples of resins included in the first electroconductive resin layer 34 and the second electroconductive resin layer 35 include various known thermosetting resins such as epoxy resin, phenoxy resin, phenol resin, polyurethane resin, silicone resin, or polyimide resin. Among these, epoxy resin is one of the appropriate resins, because of its high thermal resistance, high moisture resistance, and strong adhesion.

Preferably, the first electroconductive resin layer 34 and the second electroconductive resin layer 35 include a curing agent together with a thermosetting resin. When epoxy resin is used as a base resin, any of various known compounds such as, for example, phenolic, aminic, acid anhydride, imidazole, active ester, or polyamide-imide compounds may be used as a curing agent.

The first electroconductive resin layer 34 and the second electroconductive resin layer 35 may have a thickness of, for example, greater than or equal to about 10 μm and less than or equal to about 200 μm.

### Plating Layers

The plating layers are described below. As described above, the plating layers include an inner plating layer and an outer plating layer. More specifically, the plating layer includes two layers, for example. However, the plating layer may have a single layer or multiple layers.

### Inner Plating Layers

The inner plating layers are disposed on the electroconductive resin layers. The inner plating layers each cover at least a portion of the electroconductive resin layer. The inner plating layers include the first inner plating layer 36 and the second inner plating layer 37. The first inner plating layer 36 is disposed on the first electroconductive resin layer 34. The second inner plating layer 37 is disposed on the second electroconductive resin layer 35.

The first inner plating layer 36 and the second inner plating layer 37 may be Ni plating layers. When the inner plating layers are Ni plating layers, for example, base electrode layers are prevented from being corroded by solder when the multilayer ceramic capacitor 1 is to be mounted.

### Outer Plating Layers

The outer plating layers are disposed on the inner plating layers. The outer plating layers each cover at least a portion of the inner plating layer. The outer plating layers include the first outer plating layer 38 and the second outer plating layer 39. The first outer plating layer 38 is disposed on the first inner plating layer 36. The second outer plating layer 39 is disposed on the second inner plating layer 37.

The first outer plating layer 38 and the second outer plating layer 39 may be Sn plating layers, for example. The Sn plating layers have high solder wettability. Thus, when the outer plating layers are Sn plating layers, mounting of the multilayer ceramic capacitor 1 on, for example, a board can be facilitated.

Metals as materials of the inner plating layers or the outer plating layers are not limited to the above examples. Plating layers including the inner plating layers and surface plating layers may include at least one of, for example, metal including Cu, Ni, Ag, Pd, Au or Sn, or alloys including a Ag—Pd alloy.

Preferably, each plating layer may have a thickness of greater than or equal to about 3 μm and less than or equal to about 9 μm, for example.

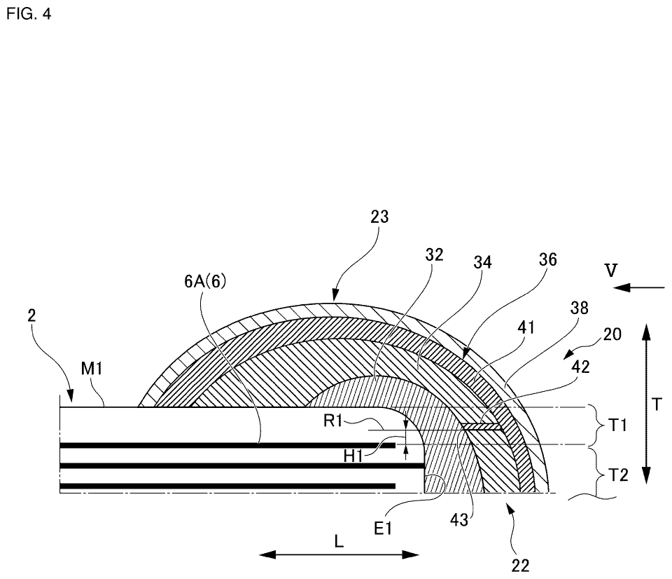

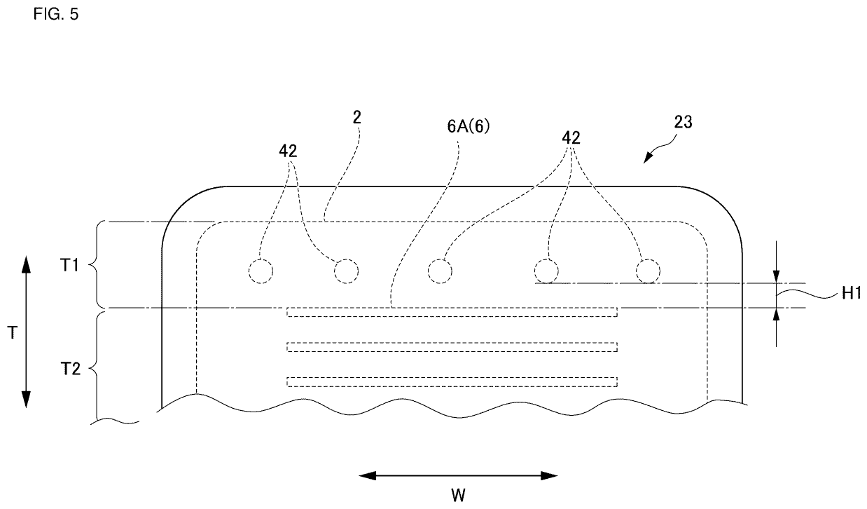

With reference to FIG. 4 and FIG. 5, the first outer electrode layer 20 is described below. FIG. 4 is an enlarged view of an area P1 in FIG. 2, and is a partial cross-sectional view of the multilayer ceramic capacitor. FIG. 5 is a diagram of the multilayer ceramic capacitor viewed in the direction indicated by arrow V in FIG. 4, and is a partial side view of the multilayer ceramic capacitor viewed in the length direction. The second outer electrode layer 21 is the same or substantially the same as the first outer electrode layer 20, is thus not described.

FIG. 4 illustrates the first over-first-end-surface outer electrode layer 22, and the first over-first-main-surface outer electrode layer 23 of the first outer electrode layer 20. In the first over-first-main-surface outer electrode layer 23, the first base electrode layer 32 covers a portion of the first main surface M1. The first electroconductive resin layer 34 covers the first base electrode layer 32, and covers a portion of the first main surface M1. The first inner plating layer 36 and the first outer plating layer 38 cover the first electroconductive resin layer 34, and cover a portion of the first main surface M1.

The first inner plating layer 36 includes a plating layer body 41 and connection areas 42. The plating layer body 41 is a portion disposed on the first electroconductive resin layer 34. The connection areas 42 extend from the plating layer body 41 through the first electroconductive resin layer 34, and are connected to the first base electrode layer 32. A connection portion 43 between each connection area 42 and the first base electrode layer 32 is positioned adjacent to the first outermost inner electrode layer 6A. “The location near the first outermost inner electrode layer 6A” is, in the height direction T, the same position as the first outermost inner electrode layer 6A or a position within a predetermined range from the same position on each side (for example, less than or equal to about 5 μm).

This prevents the base electrode layer from being completely covered by the electroconductive resin layer, and reduces or prevents an increase in electron-spin resonance (ESR). This can maintain the thickness of the electroconductive resin layer (has no need of reducing the thickness of the electroconductive resin layer), and thus reduce or prevent degradation in bending strength.

More specifically, as illustrated in FIG. 5, multiple connection areas 42 are provided. In the present example embodiment, the connection areas 42 have a circular or substantially circular cross section, and are arranged in a line in the width direction W.

The holes in the electroconductive resin layer corresponding to the connection areas 42 are formed by laser processing, for example. Each hole may be formed by, for example, a single pulse emission of a laser, or multiple pulse emissions of a laser.

The connection areas 42 extend rectilinearly parallel to a reference surface R1 extending in the length direction L and the width direction W.

Each connection portion 43 is positioned closer to the first main surface M1 than to the inner layer portion T2 in the height direction T. More specifically, each connection portion 43 is positioned outward of the inner layer portion T2 in the height direction T. This structure can thus maintain an access path along which a moisture-resistance degradation component enters through the inner electrode away from the inner electrode, and thus improve the moisture resistance.

Each connection portion 43 is spaced outward from the first outermost inner electrode layer 6A by, for example greater than or equal to about 2 μm in the height direction T. More specifically, for example, H1 in FIG. 4 and FIG. 5 is greater than or equal to about 2 μm. This structure can thus maintain an access path along which a moisture-resistance degradation component enters through the inner electrode away from the inner electrode, and thus improve the moisture resistance.

The connection portion 43 is positioned closer to the second main surface M2 than to the first main surface M1 in the height direction T. More specifically, the connection portion 43 is positioned within the first outer layer portion T1 in the height direction T. This structure can thus keep the starting point of stress propagation away from the outer surface (the mount surface) on which the bending stress is more likely to concentrate.

The dimension of the connection areas 42 in the length direction L is, for example, greater than or equal to about 1.5 μm. More specifically, while the thickness of the second electroconductive resin layer 35 is maintained at greater than or equal to about 1.5 μm, the second inner plating layer 37 and the second base electrode layer 33 are directly and partially connected to each other, and thus degradation of moisture resistance can be reduced or prevented.

In the vertical section of the multilayer body 2 parallel or substantially parallel to the width direction W, the connection areas 42 are circular or substantially circular, with a diameter of greater than or equal to about 10 μm, and less than or equal to about 200 μm, for example. The diameter of greater than or equal to about 10 μm can prevent excessive reduction of the area of the connection portion 43, and thus can reduce or prevent an increase in ESR. The diameter of less than or equal to about 200 μm can prevent excessive increase of the area, and thus can reduce or prevent degradation of moisture resistance.

When each connection area 42 has a shape other than a circle, preferably, the connection area 42 has, for example, a minimum width of greater than or equal to about 10 μm and less than or equal to about 200 μm.

As illustrated in FIG. 5, when viewed in the length direction L, the total connection area (for example, the total area of the connection portions 43) with respect to the area of the first outer layer portion T1 is, for example, preferably within the range of about 0.01% to about 10.0%, or more preferably within the range of about 0.1% to about 1.0%.

The multilayer ceramic capacitor 1 may have any dimensions.

### Method for Manufacturing Multilayer Ceramic Capacitor

An example of a method for manufacturing the multilayer ceramic capacitor 1 is described below.
(1) The dielectric sheet and an electroconductive paste for the inner electrode are prepared. The dielectric sheet and the electroconductive paste for the inner electrode include a binder and a solvent. For example, a known organic binder and a known organic solvent may be used as the binder and the solvent.
(2) The electroconductive paste for the inner electrode is applied onto the dielectric sheet in a predetermined pattern to form an inner electrode pattern. The printing may be performed by, for example, screen printing or photogravure.
(3) A predetermined number of dielectric sheets for use as outer layers are laminated. The inner electrode pattern is not printed on the dielectric sheets for use as outer layers. The dielectric sheets on which the inner electrode pattern is printed are sequentially laminated on the dielectric sheets for use as outer layers. Furthermore, a predetermined number of dielectric sheets for use as outer layers are laminated on the dielectric sheets on which the inner electrode pattern is printed. Thus, a multilayer sheet is manufactured.
(4) When the multilayer sheet is pressed in the height direction, a multilayer block is manufactured. The multilayer sheet is pressed by, for example, isostatic pressing.
(5) The multilayer block is cut into a predetermined size. Thus, the multilayer block is cut into multilayer chips. At this time, the corner portions and ridgeline portions of the multilayer chip may be rounded. Rounding may be performed by, for example, barrel finishing.
(6) The multilayer chips are fired. Thus, the multilayer bodies are manufactured. The firing temperature is, for example, preferably greater than or equal to about 900° C. and less than or equal to about 1400° C. The firing temperature may be changed depending on the material of the piezoelectric body and the inner electrodes.

### Base Electrodes

(7) An electroconductive paste that is to be formed into base electrodes is applied to both end surfaces of the multilayer body to form base electrode layers. In the present example embodiment, baked layers are formed as the base electrode layers. To form baked layers, the electroconductive paste is applied to predetermined positions of the multilayer body. The electroconductive paste includes a glass component and a metal. The application may be performed by, for example, dipping. After the application, the baking process is performed to form the base electrode layers. The temperature of the baking process is, for example, preferably greater than or equal to about 700° C. and less than or equal to about 950° C.

### Electroconductive Resin Layers

(8) The electroconductive resin layers are formed on the base electrode layers. To form the electroconductive resin layers, first, an electroconductive resin paste is prepared. The electroconductive resin paste includes a resin component and a metal component. This electroconductive resin paste is applied onto the base electrode layers. This application may be performed by dipping, for example. After the application, the resultants undergo a thermal process at a temperature of, for example, greater than or equal to about 200° C. and less than or equal to about 550° C. Resin is thermally cured with this thermal process. Thus, the electroconductive electrode layers are formed. A nitrogen gas atmosphere, for example, is preferable used as the atmosphere during the thermal process. In addition, to prevent scattering of resin and oxidation of each metal component, preferably, the oxygen content is less than or equal to about 100 ppm, for example.

After the electroconductive resin layers are formed, holes are formed by, for example, a laser to extend through the electroconductive resin layers and to have an intended angle, shape, and size. Examples of the laser conditions may include, for example, an oscillation wavelength of about 800 nm to about 1000 nm and an output energy of about 6 mJ/pulse to about 9 mJ/pulse.
(9) After the electroconductive resin layers are formed, Ni plating layers are formed on the surfaces of the electroconductive resin layers to define and function as a first inner plating layer and a second inner plating layer. Thus, portions of the Ni plating layers enter the holes in the electroconductive resin layers to be formed into the connection areas 42. Thus, the first base electrode layer 32 and the first inner plating layer 36 are directly connected. The first Ni plating layer and the second Ni plating layer may be formed by electrolytic plating, for example. Preferably, plating is barrel plating, for example.

### Second Example Embodiment

In the first example embodiment, the connection areas extend parallel or substantially parallel to the reference surface. However, the direction in which the connection areas extend is not limited to the direction described in the first example embodiment.

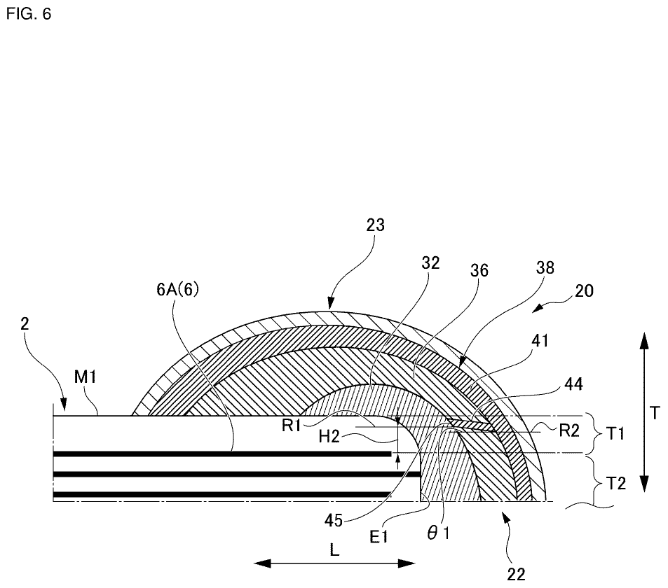

With reference to FIG. 6, a second example embodiment of the present invention is described. FIG. 6 is a partial cross-sectional view of a multilayer ceramic capacitor according to the second example embodiment.

The first inner plating layer 36 includes a plating layer body 41 and connection areas 44. The plating layer body 41 is a portion disposed on the first electroconductive resin layer 34. The connection areas 44 extend from the plating layer body 41 through the first electroconductive resin layer 34, and are connected to the first base electrode layer 32. A connection portion 45 between each connection area 44 and the first base electrode layer 32 is positioned adjacent to the first outermost inner electrode layer 6A.

As illustrated in FIG. 6, the connection areas 44 extend rectilinearly to be spaced outward from the reference surface R1 in the height direction T as they extend toward the connection portions 45.

In the vertical section of the multilayer body 2 in the length direction L, an angle θ1 between the connection area 44 relative to the reference surface R1 is greater than or equal to about 0° and less than or equal to about 60°, for example. More preferably, the angle θ1 is, for example, 20° to 40°.

Thus, stress produced when the first inner plating layer 36 and the first base electrode layer 32 are in direct contact with each other can be directed in a direction toward the outside of the multilayer body. Thus, stress propagation to the inside of the multilayer body 2 can be reduced.

The connection portions 45 are positioned closer to the first main surface M1 than to the inner layer portion T2 in the height direction T. More specifically, the connection portion 45 is positioned outward of the inner layer portion T2 in the height direction T. This structure can maintain an access path along which a moisture-resistance degradation component enters through the inner electrode away from the inner electrode, and thus improve the moisture resistance.

The connection portions 45 are spaced outward from the first outermost inner electrode layer 6A by, for example, greater than or equal to about 2 μm in the height direction T. More specifically, H2 in FIG. 6 is greater than or equal to about 2 μm, for example. This structure can thus maintain an access path along which a moisture-resistance degradation component enters through the inner electrode away from the inner electrode, and thus improve the moisture resistance.

The connection portions 45 are positioned closer to the second main surface M2 than to the first main surface M1 in the height direction T. More specifically, the connection portions 45 are positioned within the first outer layer portion T1 in the height direction T. This structure can thus keep the starting point of stress propagation away from the outer surface (the mount surface) on which the bending stress is more likely to concentrate.

The multilayer ceramic capacitor according to the second example embodiment is also capable of reducing or preventing degradation of bending strength and moisture resistance while reducing or preventing an excessive increase of electric resistance.

### Third Example Embodiment

In the first example embodiment and the second example embodiment, the connection areas in the plating layer have a thin stick shape, but the shape of the connection areas is not particularly limited.

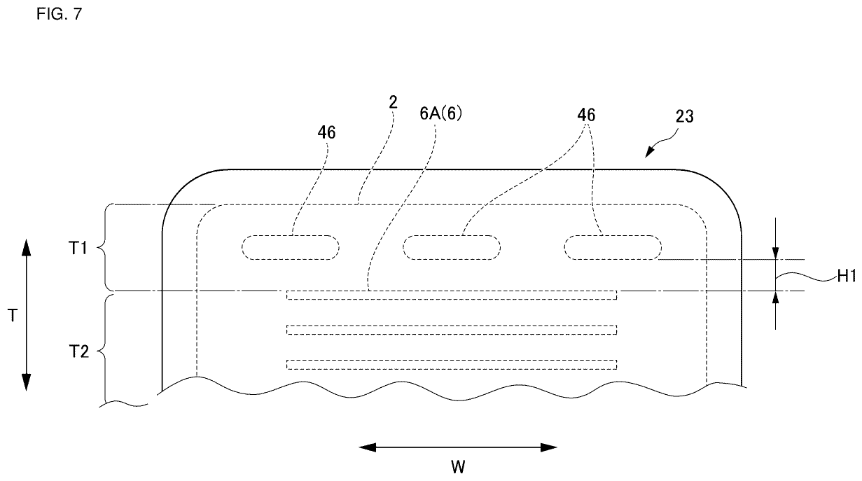

With reference to FIG. 7, a third example embodiment of the present invention is described. FIG. 7 is a partial side view of a multilayer ceramic capacitor according to a third example embodiment viewed in a length direction of the multilayer ceramic capacitor. The basic structure of the multilayer ceramic capacitor according to the third example embodiment is the same or substantially the same as the basic structure of the multilayer ceramic capacitor according to the first example embodiment, and thus, only different points are described below.

As illustrated in FIG. 7, the multilayer ceramic capacitor according to the third example embodiment includes multiple connection areas 46. In the present example embodiment, the connection areas 46 each have a cross section long in the width direction W, and are arranged in a line in the width direction W.

The holes in the electroconductive resin layer corresponding to the connection areas 46 are formed by, for example, laser processing. The holes may be formed by, for example, multiple pulse emissions.

The multilayer ceramic electronic component according to the third example embodiment is also capable of reducing or preventing degradation of bending strength and moisture resistance while reducing or preventing an excessive increase of electric resistance.

### Modified Example

Although example embodiments of the present invention have been described above, the present invention is not limited to the above example embodiments and may be modified or changed in various manners.

The holes may be formed in the electroconductive resin layer using a device other than a laser.

The number, the position, the cross-sectional shape, the extension direction, and the cross-sectional area of connection areas in the plating layer are not particularly limited. As a modified example of the first example embodiment, multiple first areas may be provided in the width direction W or the height direction T. The multiple first areas may be disposed over, for example, the entire or substantially the entire surface of the first outer layer portion. As a modified example of the second example embodiment, the holes in the electroconductive resin layer corresponding to the multiple first areas may extend in the height direction T or in another direction.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component, comprising:
a multilayer body including a first surface and a second surface opposed to each other in a lamination direction, a third surface and a fourth surface opposed to each other in a first direction orthogonal or substantially orthogonal to the lamination direction, and a fifth surface and a sixth surface opposed to each other in a second direction orthogonal or substantially orthogonal to the lamination direction and the first direction;
a first outer electrode on the third surface; and
a second outer electrode on the fourth surface; wherein
the multilayer body includes:
an inner layer portion including a plurality of inner electrodes and a plurality of dielectric layers laminated on one another, the inner layer portion including an area extending from a first inner electrode positioned closest to the first surface to a second inner electrode positioned closest to the second surface;
a first outer layer portion laminated on a portion of the inner layer portion closer to the first surface; and
a second outer layer portion laminated on a portion of the inner layer portion closer to the second surface;
the first outer electrode includes:
a base electrode layer;
a resin electrode layer on the base electrode layer; and
a plating layer on the resin electrode layer;
the plating layer includes:
a plating layer body; and
a connection area extending from the plating layer body through the resin electrode layer and connected to the base electrode layer; and
a connection portion between the connection area and the base electrode layer is adjacent to the first inner electrode.

2. The multilayer ceramic electronic component according to claim 1, wherein
the connection area extends rectilinearly parallel or substantially parallel to a reference surface extending in the first direction, or extends rectilinearly to be spaced outward from the reference surface in the lamination direction toward the connection portion; and
in a vertical section of the multilayer body in the first direction, an angle of the connection area with respect to the reference surface is greater than or equal to about 0°to less than or equal to about 60°.

3. The multilayer ceramic electronic component according to claim 1, wherein the connection portion is closer to the first surface than to the inner layer portion in the lamination direction.

4. The multilayer ceramic electronic component according to claim 3, wherein the connection portion is spaced outward from an inner electrode of the plurality of inner electrodes closest to the first surface by greater than or equal to about 2 μm in the lamination direction.

5. The multilayer ceramic electronic component according to claim 3, wherein the connection portion is closer to the second surface than to the first surface in the lamination direction.

6. The multilayer ceramic electronic component according to claim 1, wherein a dimension of the connection area in the first direction is greater than or equal to about 1.5 μm.

7. The multilayer ceramic electronic component according to claim 1, wherein in a vertical section of the multilayer body parallel or substantially parallel to the second direction, a minimum width of the connection area is greater than or equal to about 10 μm and less than or equal to about 200 μm.

8. The multilayer ceramic electronic component according to claim 1, wherein the plating layer includes Ni.

9. The multilayer ceramic electronic component according to claim 1, wherein each of the plurality of dielectric layers includes BaTiO₃, CaTiO₃, SrTiO₃, or CaZrO₃ as a main component.

10. The multilayer ceramic electronic component according to claim 1, wherein a thickness of each of the plurality of dielectric layers is greater than or equal about to 0.5 μm and less than or equal to about 10 μm.

11. The multilayer ceramic electronic component according to claim 1, wherein each of the plurality of inner electrodes includes Ni, Cu, Ag, Pd, or Au, or an alloy including any of Ni, Cu, Ag, Pd, or Au.

12. The multilayer ceramic electronic component according to claim 1, wherein a thickness of each of the plurality of inner electrodes is greater than or equal to about 0.2 μm and less than or equal to about 2.0 μm.

13. The multilayer ceramic electronic component according to claim 1, wherein the base electrode layer includes an electroconductive metal and a glass component.

14. The multilayer ceramic electronic component according to claim 13, wherein the electroconductive metal includes at least one of Cu, Ni, Ag, Pd, an Ag—Pd alloy, or Au.

15. The multilayer ceramic electronic component according to claim 13, wherein the glass component includes at least one of B, Si, Ba, Mg, Al, or Li.

16. The multilayer ceramic electronic component according to claim 1, wherein the resin electrode layer includes a resin component and a metal component.

17. The multilayer ceramic electronic component according to claim 16, wherein the reason component includes epoxy resin, phenol resin, polyurethane resin, silicone resin, or polyimide resin.

18. The multilayer ceramic electronic component according to claim 1, wherein the connection area has a circular or substantially circular cross section.

19. The multilayer ceramic electronic component according to claim 1, wherein a plurality of the connection areas are provided in the first outer electrode.

20. The multilayer ceramic electronic component according to claim 1, wherein a thickness of the reason electrode layer is greater than or equal to about 1.5 μm.
